(19) United States
(12) Patent Application Publication
(10) Pub. No.: US 2005/0263948 A1
(43) Pub. Date: Dec. 1, 2005

(54) Clamps useful for film stretching

(76) Inventor: Stefan Tobolka, Mississauga (CA)

Correspondence Address: SMART AND BIGGAR, 438 UNIVERSITY AVENUE, SUITE 1500 BOX 111, TORONTO, ON, M5G2K8, CA

(21) Appl. No.: 10/854,259

(22) Filed: May 27, 2004

(51) Int. Cl. B25B 1/24

(52) U.S. Cl. 269/257

(57) ABSTRACT

A clamp may have an outer base member with an inner ramp surface and an inner clamping member with an outer ramp surface abutting the inner ramp surface of the base member. The inner clamping member may have an inner clamping surface for engaging an element to be clamped, such as a film. The inner and outer ramp surfaces are configured such that, with said clamping member backstopped, compression of the base member toward the film forces the clamping member to slide along said inner ramp surface of the base member. The result is that the film is tugged by the clamp. This tugging force may be used to stretch the film.

### BACKGROUND

This invention relates to a clamp construction which can be used for clamps for film stretching.

In a vertical form, fill, and seal machine, a sheet of film is sealed into a tube around a spigot. The base of the tube is then sealed and a flowable material is introduced into the tube. A transverse seal may then be formed above the sealed base and the tube cut along this seal to form a pouch filled with the flowable material. The seal above the cut line becomes the new bottom seal so that the process may be repeated to form additional pouches.

The transverse seal is typically formed by a heated ribbon. If the film tube is not controlled along the line of the seal, wrinkles will result along the line of seal. Wrinkles weaken the seal and, where the flowable material is a liquid, such as water, risk forming a pouch that leaks.

To reduce the incidence of wrinkles, it is known to clamp the edges of the film tube while sealing. Nevertheless, even with the edges of the tube clamped, wrinkles can result in the seals.

This invention therefore seeks to provide a clamp that may be used in controlling a film to reduce wrinkles while sealing.

### SUMMARY OF INVENTION

A clamp may have an outer base member with an inner ramp surface and an inner clamping member with an outer ramp surface abutting the inner ramp surface of the base member. The inner clamping member may have an inner clamping surface for engaging an element to be clamped, such as a film. The inner and outer ramp surfaces are configured such that, with said clamping member backstopped, compression of the base member toward the film forces the clamping member to slide along said inner ramp surface of the base member. The result is that the film is tugged by the clamp. This tugging force may be used to stretch the film.

In accordance with this invention, there is provided a clamp comprising: an outer base member having an inner ramp surface; an inner clamping member having an outer ramp surface abutting said inner ramp surface of said base member and an inner clamping surface for engaging an element to be clamped; said inner ramp surface and said outer ramp surface configured such that, with said clamping member backstopped, compression of said base member toward said element to be clamped forces said clamping member to slide along said inner ramp surface of said base member.

In accordance with another aspect of the present invention, there is provided a pair of opposed clamps, comprising: a first clamp, comprising: a first outer base member; a first inner clamping member having an inner clamping surface for engaging an element to be clamped; at least one of said first base member and said first clamping member having a ramp surface for slidingly engaging another of said first base member and said first clamping member; a second, opposed, clamp, comprising: a second outer base member; a second inner clamping member having an inner clamping surface for engaging said member to be clamped; at least one of said second base member and said second clamping member having a ramp surface for slidingly engaging another of said second base member and said second clamping member; each said ramp surface configured such that compression of said first base member toward said second base member forces said first clamping member to slide along said first base member and said second clamping member to slide along said second base member thereby to pull said member to be clamped.

In accordance to a further aspect of the invention, there is provided a vertical form, fill, and seal machine, comprising: a first pair of opposed clamps at one side of a web processed by said vertical form, fill, and seal machine for intermittently clamping said web; a second pair of opposed clamps at an opposite side of said web for intermittently clamping said web; each pair of opposed clamps comprising: a first clamp, comprising: a first outer base member; a first inner clamping member having an inner clamping surface for engaging said web; at least one of said first base member and said first clamping member having a ramp surface for slidingly engaging another of said first base member and said first clamping member; a second, opposed, clamp, comprising: a second outer base member; a second inner clamping member having an inner clamping surface for engaging said web; at least one of said second base member and said second clamping member having a ramp surface for slidingly engaging another of said second base member and said second clamping member; each said ramp surface configured such that, compression of said first base member toward said second base member forces said first clamping member to slide along said first base member and said second clamping member to slide along said second base member; said first pair of opposed clamps and said second pair of opposed clamps oriented such that, when clamping said web, said first pair of opposed clamps and said second pair of opposed clamps tension said web.

In accordance to a yet further aspect of the invention, there is provided a method for tensioning a web, comprising: compressing a first base member of a first clamp toward a second base member of an opposed second clamp so that a first clamping member having an inner surface engaging said web and an outer surface abutting a ramp of said first base member and a second clamping member having an inner surface engaging said web and an outer surface abutting a ramp of said second base member move together, each moving along its respective base member, and compressing a third base member of a third clamp toward a fourth base member of an opposed fourth clamp so that a third clamping member having an inner surface engaging said web and an outer surface abutting a ramp of said third base member and a fourth clamping member having an inner surface engaging said web and an outer surface abutting a ramp of said fourth base member move together, each moving along its respective base member, and moving away from said first clamping member and said second clamping member, whereby said web is tensioned.

In accordance to another aspect of the invention, there is provided a pair of opposed clamps, comprising: a first clamp, comprising: a first outer base member having an inner ramp surface; a first inner clamping member having an inner clamping surface for engaging an element to be clamped and an outer ramp surface riding along said inner ramp surface of said outer base member; a second, opposed, clamp, comprising: a second outer base member having an inner ramp surface; a second inner clamping member having an inner clamping surface for engaging said member to be clamped and an outer ramp surface riding along said inner ramp surface of said outer base member; said first outer base member ramp surface inclining toward said second outer base member ramp surface.

Other features and advantages of the invention will become apparent by reference to the following description, in conjunction with the drawings.

### DESCRIPTION OF THE DRAWINGS

In the figures which illustrate example embodiments of the invention,

FIG. 1 is a schematic view of a vertical form, fill, and seal machine;

FIG. 2 is a side elevational view of a portion of FIG. 1,

FIG. 3 is a front view of a portion of FIG. 2,

FIG. 4 is a perspective view of the clamps of FIG. 3,

FIG. 5 is an exploded view of FIG. 4,

FIGS. 6 and 7 are schematic top views illustrating operation of the clamps,

FIG. 8 is an exploded view of an alternate embodiment for the clamps of FIG. 3,

FIG. 8A is a plan view of a portion of one of the clamps of FIG. 8, and

FIG. 9 is a side view of the clamps of FIG. 8.

### DETAILED DESCRIPTION

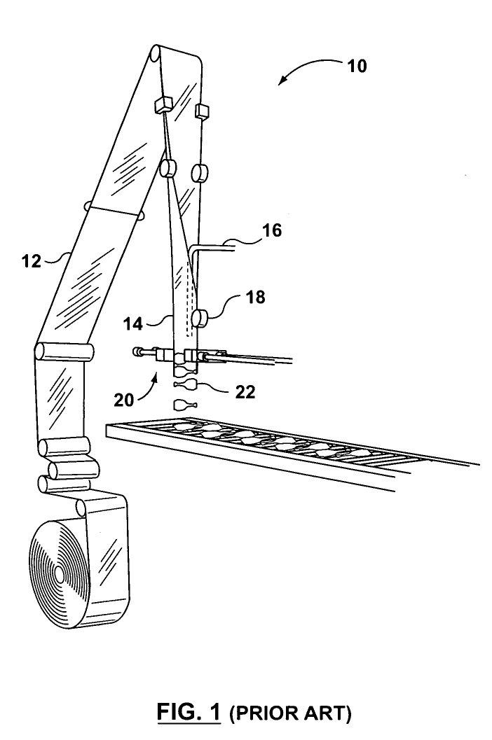

Turning to FIG. 1, in a vertical form, fill, and seal machine 10, a web of film 12 is formed into a tube 14 of film about a spigot 16. The film may be sealed into the tube by a cylindrical sealing head 18. A reciprocating sealing head assembly 20 may form transverse seals across the tube and sever pouches 22 from the tube.

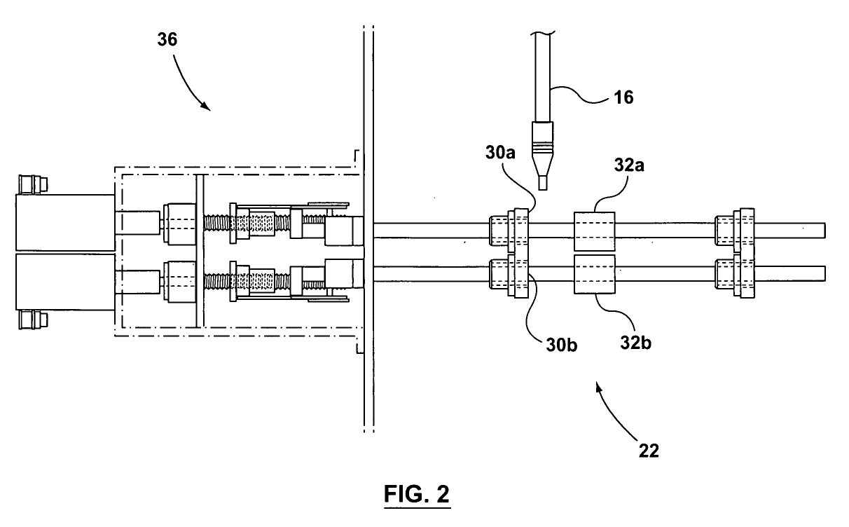

Referencing FIG. 2, the sealing head assembly 22 comprises an upper sealing head 30a with an opposed backstop 32a and a lower sealing head 30b with an opposed backstop 32b. Drive trains indicated generally at 36 are provided to control reciprocation of the sealing heads and backstops such that the film tube 14 may be selectively “pinched” between the sealing heads and backstops in order to form transverse seals across the tube 14. Suitable drive trains are described in further detail in a co-pending, commonly owned, application Ser. No. 10/720,224 filed Nov. 25, 2003 naming David B. Kochan as inventor, the contents of which are incorporated by reference herein.

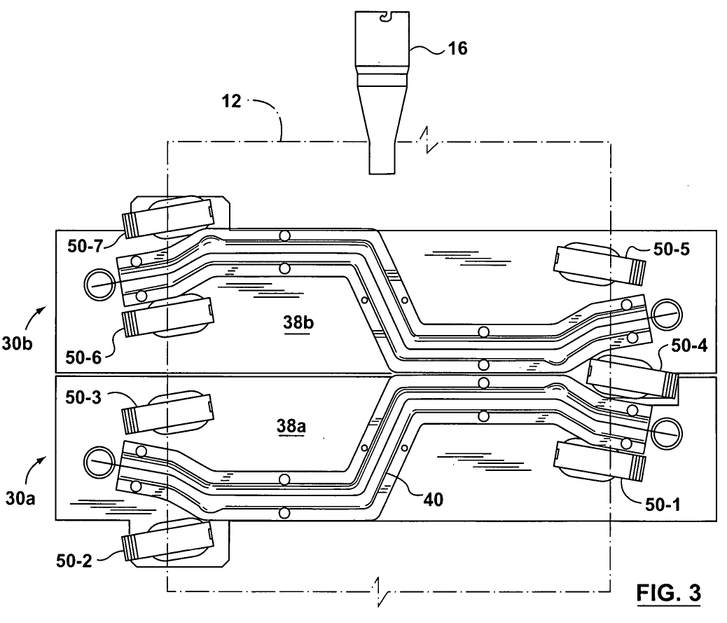

As shown in FIG. 3, each sealing head 30a, 30b has a mounting plate 38a, 38b, respectively, that supports a heat sealing ribbon 40. Three clamps 50-1, 50-2, and 50-3, are supported by mounting plate 38a and a four additional clamps 50-4, 50-5, 50-6, and 50-7 are supported by mounting plate 38b. Similarly, backstop 32a supports three clamps (not shown) opposed to clamps 50-1, 50-2, and 50-3 and backstop 32b supports four clamps (not shown) opposed to clamps 50-4, 50-5, 50-6, and 50-7. The clamps may be referred to individually as clamps 50.

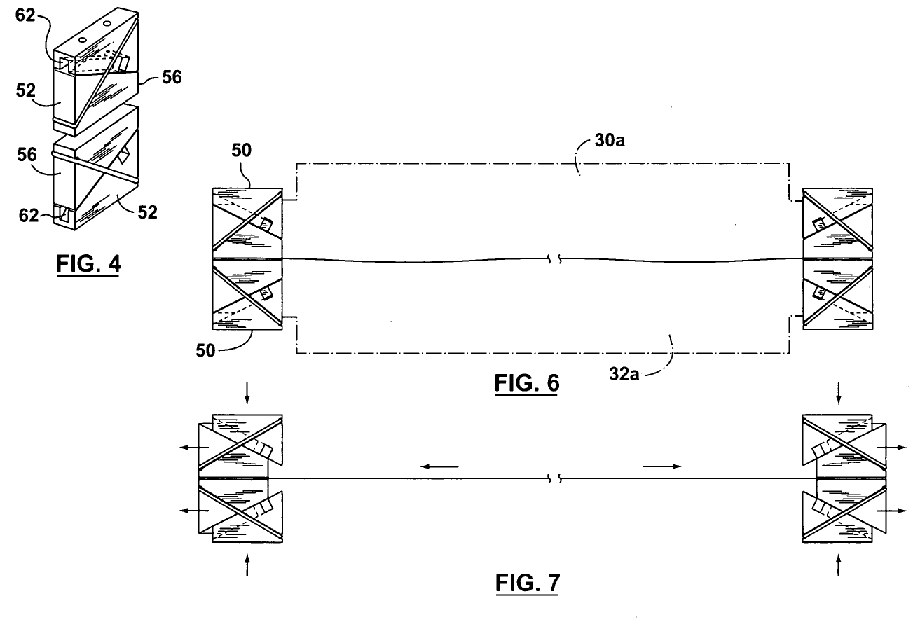

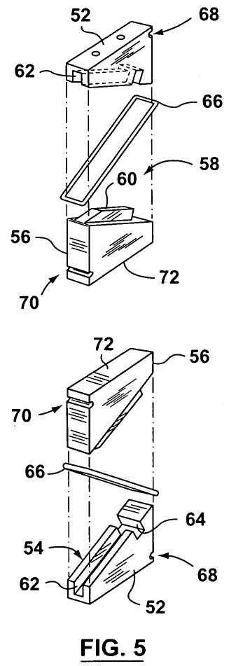

FIG. 4 is a perspective view of a pair of opposed clamps 50 and FIG. 5 is an exploded view of this same pair of opposed clamps. Turning to these figures each clamp has an outer base member 52 having an inner ramp surface 54 and an inner clamping member 56 having an outer ramp surface 58. When a clamp is assembled, the inner ramp surface 54 of the base member abuts the outer ramp surface 58 of the clamping member.

A locating ridge 60 extends along the outer ramp surface 58 of the clamping member 56. A notch 62 extends along the inner ramp surface of the base member 52 such that the notch receives the locating ridge. The notch is a blind notch, terminating at a stop 64. A resilient band 66 is received by an anchoring notch 68 in base 52 and an anchoring notch 70 in clamping member 56. Band 66 holds ridge 60 within locating notch 62 and urges the ridge to a home position whereat the ridge abuts stop 64. This is the home position of each clamp illustrated in FIG. 4.

As will be apparent from these figures, the opposed clamps 50 are oriented such that the clamping members 56 of the clamps 50 face one another and may move in the same direction away from their home position. The inner surface 72 of each of the two clamping members may be provided with a friction enhancing surface.

The clamps are mounted inwardly of the sealing heads and mounting plates such that, as illustrated in FIG. 6, opposed clamps 50 abut, but for the intervening film tube 14, prior to the sealing heads (30a shown in phantom) and backstops (32a shown in phantom) abutting. This results in the opposed clamps clamping opposite edges of the film tube 14. As the sealing heads and backstops move into abutment, but for the intervening film tube 14, the opposed clamps are forced away from their home position, as illustrated in FIG. 7. More particularly, the bases 52 of each pair of opposed clamps 50 continue to be compressed toward each other, however, the clamping members 56 are not free to further approach one another. The result is that each clamping member 56 is forced to slide along the outer ramp surface 54 of its base 52. However, because these clamping members 56 sandwich the film tube 14, the consequence is that a tugging force is applied to the film tube 14 which acts to stretch the tube laterally. The stretched film tube presents a highly uniform linear surface which may therefore be sealed with a reduced risk of sealing in wrinkles.

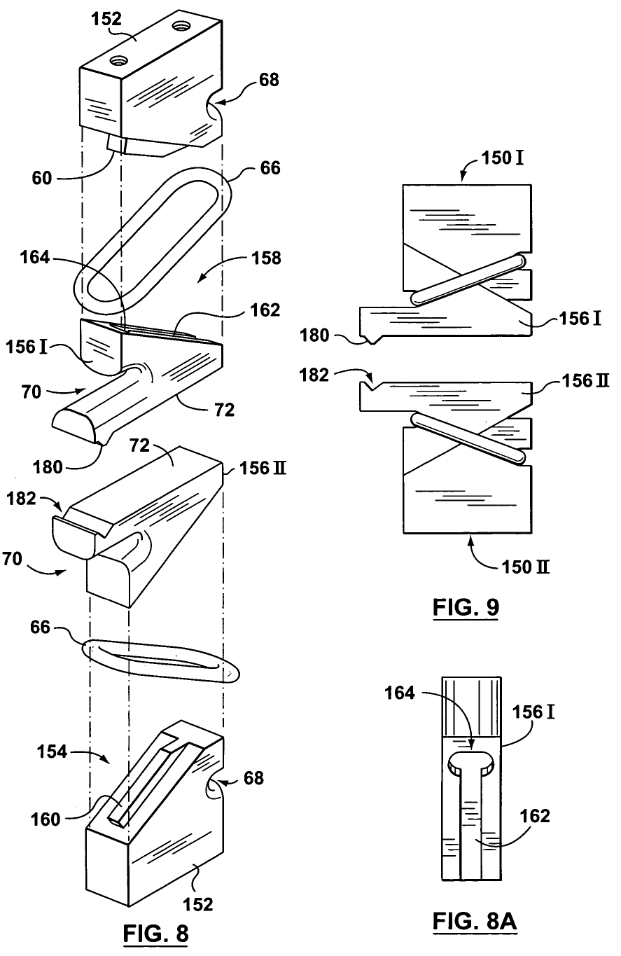

For certain types of clamped materials, it might be possible for the clamping element 56 of one of a pair of opposed clamps to slip with respect to the clamping element 56 of the other of the pair of opposed clamps. To avoid this possibility, in a further alternative embodiment illustrated in FIGS. 8, 8A, and 9, wherein like parts have been given like reference numbers, the clamping element 156I of one of the clamps 150I of each pair of clamps may be provided with an extension having a boss 180. The clamping element 156II of the other of the clamps 150II of the pair may be provided with an extension having a notch 182. With this modification, when the clamping elements 156I, 156II are brought into abutment, the boss 180 of clamping element 156I will enter notch 182 of clamping element 156II. The boss in the notch ensures that the clamping elements will move together when forced from their home position. Optionally, if only a short clamping surface was needed, the boss and notch could be provided without the need for the extensions.

As will also be apparent from the embodiment of FIGS. 8, 8A, and 9, the locating ridge 160 is located on the inner ramp surface 154 of base member 152 and the notch 162 which receives the ridge extends along the outer ramp surface 158 of the inner clamping member 156I, 156II. This is the opposite arrangement to that of FIGS. 4 and 5. Further, the blind notch 162 which is in each inner clamping member 156I, 156II has a differently configured stop 164 to the stop of the embodiment of FIGS. 4 and 5.

In an alternate embodiment, rather than employing pairs of opposed clamps 50, a single clamp may be used with an opposed backstop. With this arrangement, the backstop may be provided with a friction reduced surface and the clamp with a friction enhanced surface so that a stretching force may be applied to an intervening film.

It will be apparent that a clamp may also be used to clamp (and, optionally, stretch) materials other than a film tube of a vertical form, fill, and seal machine.

Other modifications will be apparent to those skilled in the art and, therefore, the invention is defined in the claims.

1. A clamp comprising:
an outer base member having an inner ramp surface;
an inner clamping member having an outer ramp surface abutting said inner ramp surface of said base member and an inner clamping surface for engaging an element to be clamped;
said inner ramp surface and said outer ramp surface configured such that, with said clamping member backstopped, compression of said base member toward said element to be clamped forces said clamping member to slide along said inner ramp surface of said base member.

2. The clamp of claim 1 wherein said inner clamping surface of said clamping member has a friction enhancing surface.

3. The clamp of claim 1 further comprising a stop for setting a home position for said clamping member with respect to said base member, and wherein said clamping member slides away from said home position when compression of said base member toward said clamping surface forces said clamping member to slide along said inner ramp surface of said base member.

4. The clamp of claim 3 further comprising a resilient member for urging said clamping member to said home position.

5. The clamp of claim 3 further comprising a locating ridge along one of said ramp surface of said first base member and said ramp surface of said first clamping member and a notch along another of said ramp surface of said first base member and said ramp surface of said first clamping member, said notch receiving said locating ridge.

6. The clamp of claim 5 wherein said notch is a blind notch, said blind comprising said stop.

7. A pair of opposed clamps, comprising:
a first clamp, comprising:
a first outer base member;
a first inner clamping member having an inner clamping surface for engaging an element to be clamped;
at least one of said first base member and said first clamping member having a ramp surface for slidingly engaging another of said first base member and said first clamping member;
a second, opposed, clamp, comprising:
a second outer base member;
a second inner clamping member having an inner clamping surface for engaging said member to be clamped;
at least one of said second base member and said second clamping member having a ramp surface for slidingly engaging another of said second base member and said second clamping member;
each said ramp surface configured such that compression of said first base member toward said second base member forces said first clamping member to slide along said first base member and said second clamping member to slide along said second base member thereby to pull said member to be clamped.

8. The clamps of claim 7 wherein said inner clamping surface of each of said first clamping member and said second clamping member has a friction enhancing surface.

9. The clamps of claim 7 further comprising a stop for setting a home position for said first clamping member with respect to said first base member, and wherein said first clamping member slides away from said home position when compression of said first base member toward said second base member forces said first clamping member to slide along said first base member.

10. The clamps of claim 9 further comprising a resilient member for urging said first clamping member to said home position.

11. The clamps of claim 10 wherein each of said first base member and said first clamping member has a ramp surface and further comprising a ridge along one of said ramp surface of said first base member and said ramp surface of said first clamping member and a notch along another of said ramp surface of said first base member and said ramp surface of said first clamping member, said notch receiving said ridge.

12. The clamps of claim 9 wherein said notch is a blind notch, said blind comprising said stop.

13. The clamps of claim 12 wherein said clamps are a first pair of clamps for clamping one edge of said member to be clamped and further comprising a second pair of co-operating clamps for clamping another edge of said member to be clamped such that said member to be clamped may be tensioned by said first clamps and said second clamps.

14. The clamps of claim 13 wherein said member to be clamped is a tubular web.

15. A vertical form, fill, and seal machine, comprising:
a first pair of opposed clamps at one side of a web processed by said vertical form, fill, and seal machine for intermittently clamping said web;
a second pair of opposed clamps at an opposite side of said web for intermittently clamping said web;
each pair of opposed clamps comprising:
a first clamp, comprising:
a first outer base member;
a first inner clamping member having an inner clamping surface for engaging said web;
at least one of said first base member and said first clamping member having a ramp surface for slidingly engaging another of said first base member and said first clamping member;
a second, opposed, clamp, comprising:
a second outer base member;
a second inner clamping member having an inner clamping surface for engaging said web;
at least one of said second base member and said second clamping member having a ramp surface for slidingly engaging another of said second base member and said second clamping member;
each said ramp surface configured such that, compression of said first base member toward said second base member forces said first clamping member to slide along said first base member and said second clamping member to slide along said second base member;
said first pair of opposed clamps and said second pair of opposed clamps oriented such that, when clamping said web, said first pair of opposed clamps and said second pair of opposed clamps tension said web.

16. A method for tensioning a web, comprising:
compressing a first base member of a first clamp toward a second base member of an opposed second clamp so that a first clamping member having an inner surface engaging said web and an outer surface abutting a ramp of said first base member and a second clamping member having an inner surface engaging said web and an outer surface abutting a ramp of said second base member move together, each moving along its respective base member, and
compressing a third base member of a third clamp toward a fourth base member of an opposed fourth clamp so that a third clamping member having an inner surface engaging said web and an outer surface abutting a ramp of said third base member and a fourth clamping member having an inner surface engaging said web and an outer surface abutting a ramp of said fourth base member move together, each moving along its respective base member, and moving away from said first clamping member and said second clamping member, whereby said web is tensioned.

17. A pair of opposed clamps, comprising:
a first clamp, comprising:
a first outer base member having an inner ramp surface;
a first inner clamping member having an inner clamping surface for engaging an element to be clamped and an outer ramp surface riding along said inner ramp surface of said outer base member;
a second, opposed, clamp, comprising:
a second outer base member having an inner ramp surface;
a second inner clamping member having an inner clamping surface for engaging said member to be clamped and an outer ramp surface riding along said inner ramp surface of said outer base member;
said first outer base member ramp surface inclining toward said second outer base member ramp surface.
